(19) United States
(12) Patent Application Publication
(10) Pub. No.: US 2018/0316938 A1
(43) Pub. Date: Nov. 1, 2018

(54) METHOD AND APPARATUS FOR K-TH ORDER EXP-GOLOMB BINARIZATION

(71) Applicant: CANON KABUSHIKI KAISHA, Tokyo (JP)

(72) Inventor: Gem A. dela Serna, Manila (PH)

(21) Appl. No.: 15/498,080

(22) Filed: Apr. 26, 2017

(51) Int. Cl. H04N 19/91

(52) U.S. Cl. CPC H04N 19/91

(57) ABSTRACT

There is provided a method for compressing unsigned input of data as Exp-Golomb Code, which comprises (a) deriving an offset value corresponding to kth-order parameter, (b) receiving an unsigned input data, (c) incrementing the input data by the offset value, (d) determining the most significant bit (MSB) location for the incremented value, (e) generating the suffix code word bits by extracting a plurality number of bits at left significant bit (LSB) side, that corresponds to the MSB location, from the incremented value, (f) generating the prefix code word bits code length that corresponds to the MSB location and kth-order parameter, and (g) generating the output Exp-Golomb code word by combining the prefix code word and suffix code word.

### BACKGROUND OF THE INVENTION

### Field of the Invention

The present invention relates binarization scheme, which enable effective arithmetic coding for use in video coding application.

### Description of the Related Art

The k-th order Exp-Golomb binarization (to be referred to as “EGk” hereinafter) process converts a non-negative integer data, codeNum, to a variable length code (VLC) word, which consists of prefix code and suffix code.

A unique prefix code word with a unique length is assigned to each range of codeNum, where the size of codeNum range is proportional to the prefix code length. The suffix code length is derived from the k-th order parameter value and prefix code length, while the suffix code value is derived from the difference between the codeNum value and prefix value. The prefix value corresponds to the smallest value in the codeNum range where the actual codeNum is categorized.

EGk by itself only uses unsigned input, but signed input can be encoded as described in ITU-T Rec. H.264 and ITU-T Rec. H.265, where the signed input is converted to codeNum. Hereinafter, EGk with kth-order=0 will be referred to as EG0, kth-order=1 will be referred to as EG1, and then same manner will be applied to other k-th order parameter values.

In reference with FIG. 2, the conventional techniques for encoding an integer input to Exp-Golomb code word often include the use of look-up tables (LUT), where every input value is mapped to a unique code word, prefix code word and suffix code word are combined, in the LUT. For a 16-bit input, the table will have 2¹⁶(65,536) entries, which results to a very large circuit size. Moreover, the circuit size will further increase when supporting multiple kth-order value, because different LUT will be instantiated for each kth-order parameter value.

A related art, U.S. Pat. No. 7,825,835, disclosed a solution to such problem by converting the input as shifted input then using the most significant bit (MSB) of the shifted input to generate the Exp-Golomb code word using smaller LUTs, shifters, and other simple logic components. However, disclosed solution is only applicable to EG0 and encoding for other k-th order parameter value will still require using large LUTs.

### SUMMARY OF THE INVENTION

Embodiments of the present invention are related to methods and apparatus for data compression that encodes an integer input with various values of k-th order parameter into Exp-Golomb code without the use of large LUT. The embodiments described herein advantageously generate a small circuit that can generate the Exp-Golomb code word within 1 clock cycle.

Further features of the present invention will become apparent from the following description of exemplary embodiments (with reference to the attached drawings).

### BRIEF DESCRIPTION OF THE DRAWINGS

FIG. 1 illustrates the fundamental Exp-Golomb Encoder configuration of present invention.

FIG. 2 illustrates the look-up table entries used in conventional method.

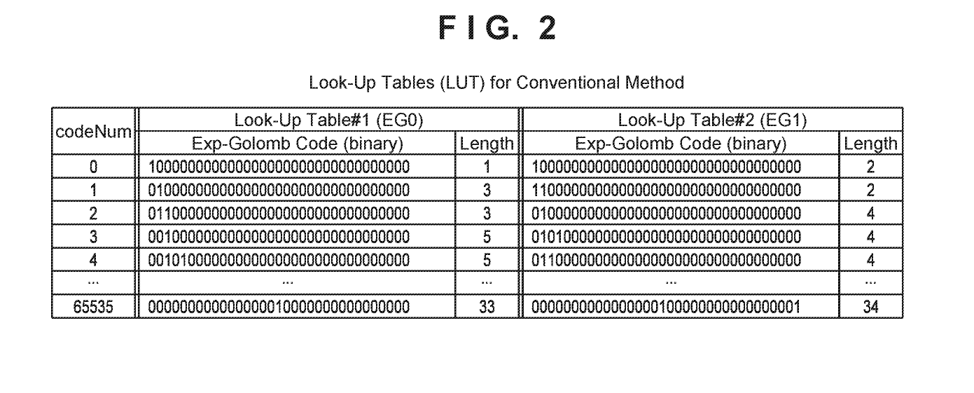

FIG. 3 illustrates the first embodiment of present invention.

FIG. 4 illustrates the second embodiment of present invention.

FIG. 5 illustrates the third embodiment of present invention.

FIG. 6 illustrates the fourth embodiment of present invention.

FIG. 7 illustrates the location where the present invention extracts the suffix code word bits.

FIG. 8 illustrates the intermediate signal values with input data equal to 4 and kth-order equal to 0.

FIG. 9 illustrates the intermediate signal values with input data equal to 4 and kth-order equal to 1.

FIG. 10 illustrates the MSB LUT truth table for the present invention.

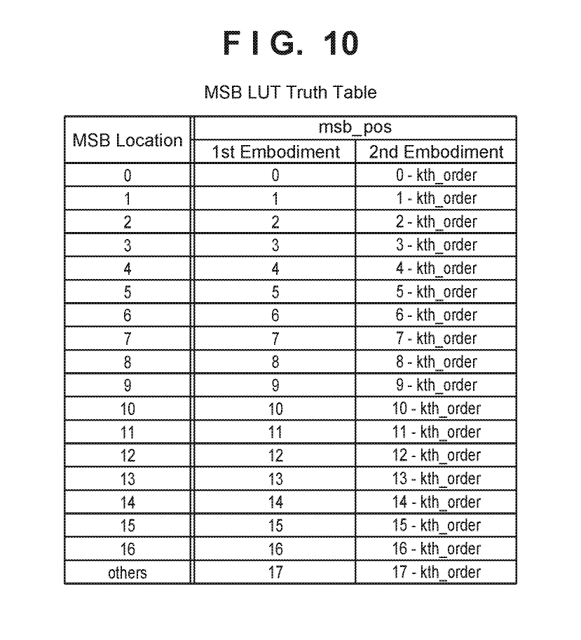

FIG. 11 illustrates the Prefix LUT truth table for the present invention.

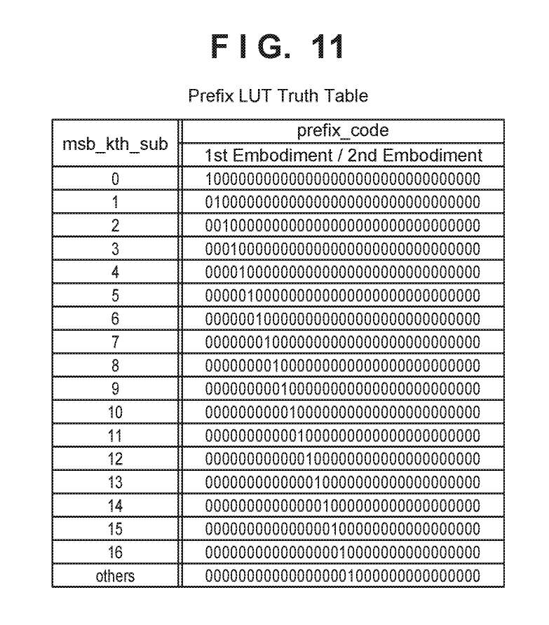

FIG. 12 illustrates the Suffix LUT truth table for the present invention.

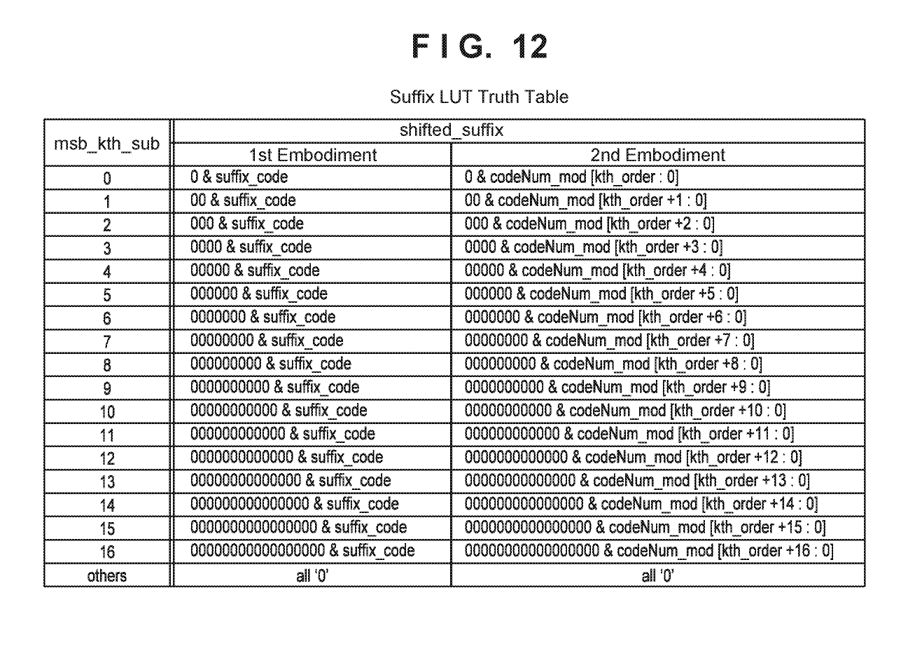

FIG. 13 illustrates the unique Exp-Golomb prefix code words and suffix code length for a given k-th order and codeNum range.

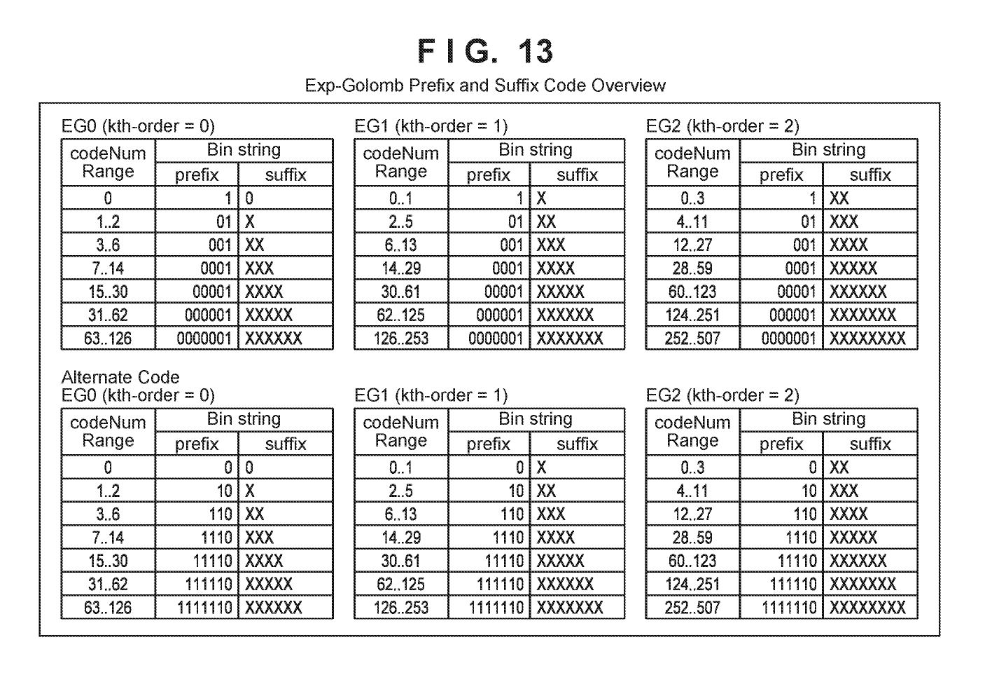

FIG. 14 illustrates the truth table for codeNum, signed input, unsigned input, and Exp-Golomb code word for different k-th order parameter value.

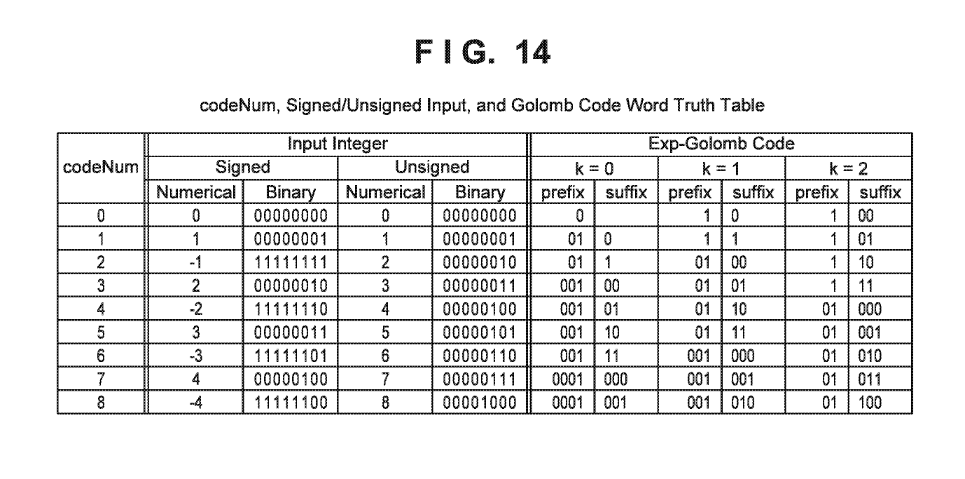

FIG. 15 illustrates the coding process of the prior art.

FIG. 16 illustrates the coding process of the present invention.

FIG. 17 is a block diagram of an example system according to the embodiment.

### DESCRIPTION OF THE EMBODIMENTS

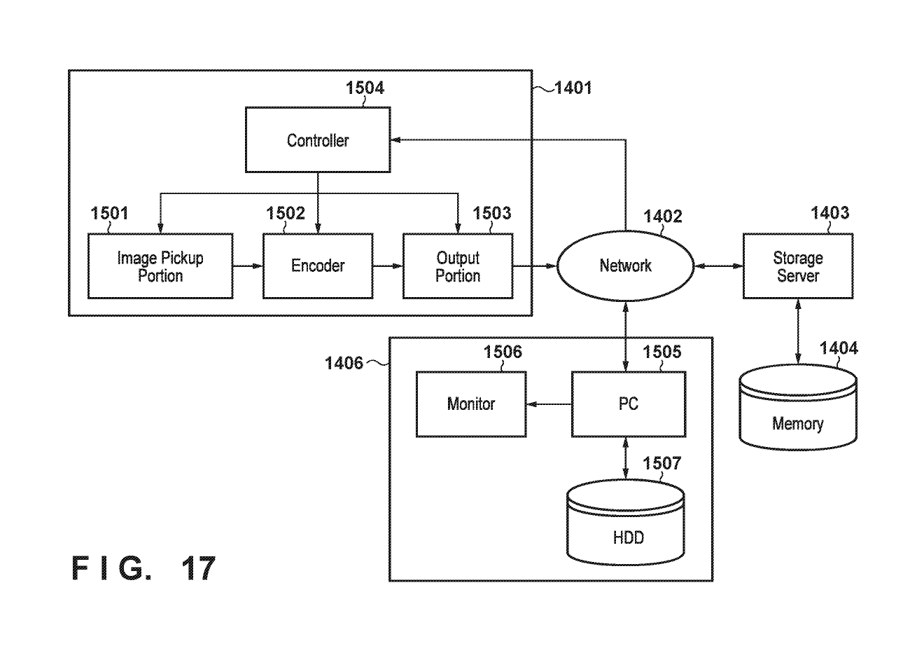

FIG. 17 is a block diagram that illustrates an internal structure of the image pickup apparatus 1401 and the moving image reproducing apparatus 1406. Referring to FIG. 17, a PC 1505 is an information processing apparatus that includes a computer-readable memory storing a program for operating the moving image reproducing apparatus 1406 and that also includes a controller executing the program. The PC 1505 receives moving image data from the image pickup apparatus 1401 or the storage server having the memory 1404 over the network 1402, causes a hard disk drive (HDD) 1507 to store the received moving image data, and causes a monitor 1506 to display it. The HDD 1507 can be another type of memory, such as a flash memory.

An image pickup portion 1501 can be composed of an image sensor. An encoder 1502 encodes moving image data obtained by the image pickup portion 1501. An output portion 1503 outputs the moving image data to the moving image reproducing apparatus 1406 or the storage server 1403 over the network 1402.

A controller 1504 controls the entire system of the image pickup apparatus 1401. For example, in response to the instruction from the moving image reproducing apparatus 1406, the controller 1504 instructs the image pickup portion 1501, the encoder 1502, and the output portion 1503 to start an image capturing operation. The obtained moving image data is output from the output portion 1503 to the moving image reproducing apparatus 1406 and the storage server 1403 having a memory 1404 over the network 1402.

In the moving image reproducing apparatus 1406, the PC 1505 stores moving image data output from the output portion 1503 in the HDD 1507. When receiving an operation to finish image capturing from a user, the PC 1505 provides the image pickup apparatus 1401 with an instruction to finish image capturing. In the embodiment, the encoder 1502 is described below.

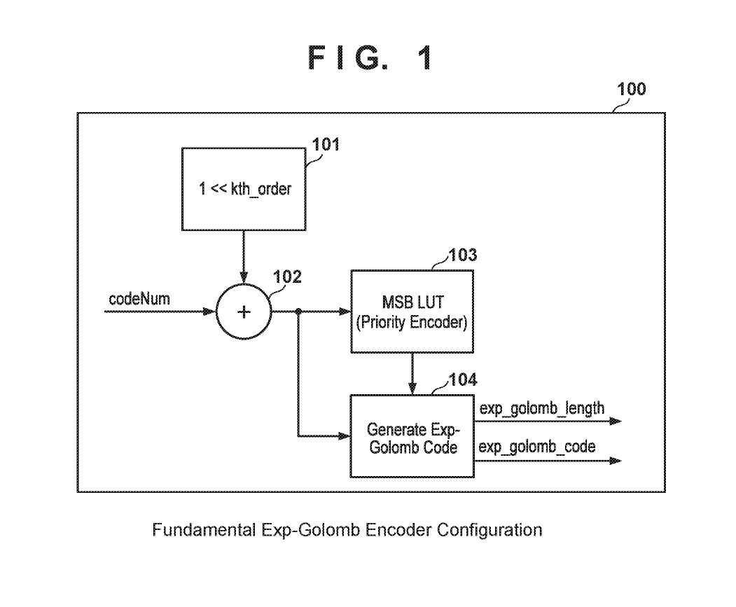

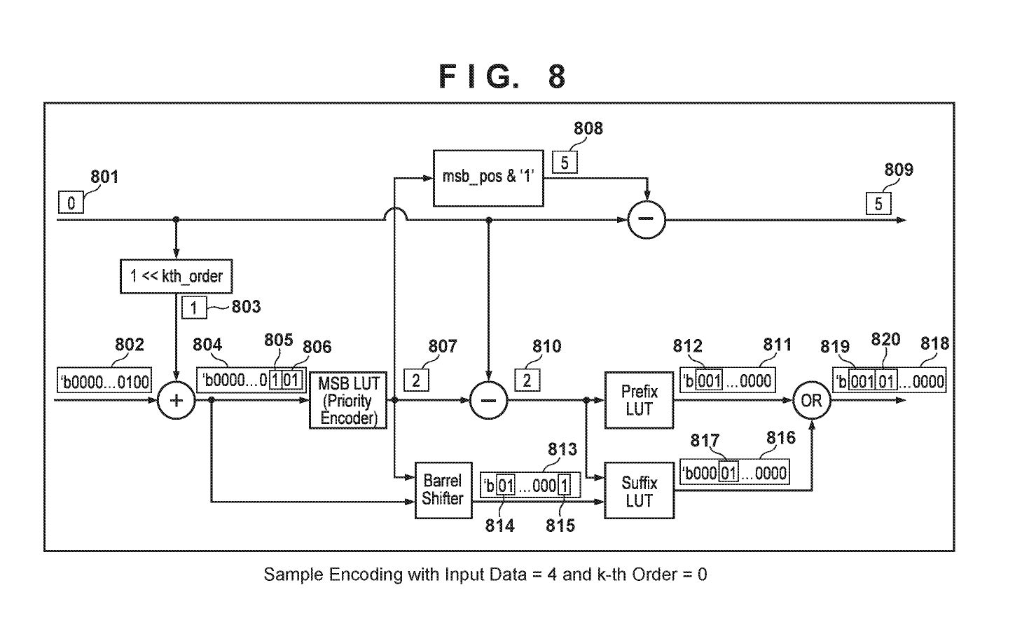

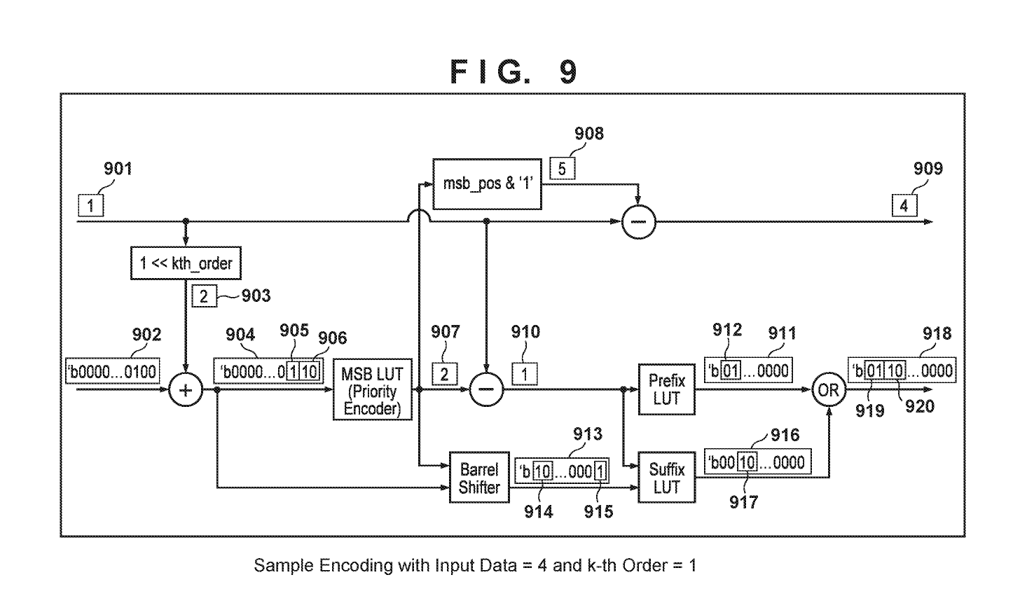

In reference with FIG. 1, FIG. 8, and FIG. 9, unit 100 illustrates the fundamental operation performed by the present invention. Unit 101 derives an offset value (803 and 903) that corresponds to the kth-order parameter value (801 and 901). Unit 102 generates the codeNum mod signal value (804 and 904) by incrementing the codeNum (802 and 902) with the output of unit 101. Unit 103, a priority encoder, determines the most significant bit (to be referred to as MSB hereinafter) location of codeNum mod (806 and 906) by sweeping through the bits of codeNum mod, starting from the MSB and progressing to least significant bit (to be referred to as LSB hereinafter) and detecting the first (most significant; 805 and 905) “1” value. Unit 104 uses the output from 103 then extracts the suffix code word bits (806 and 906) from output of unit 102 to generate the Exp-Golomb code word and code length information.

### First Embodiment

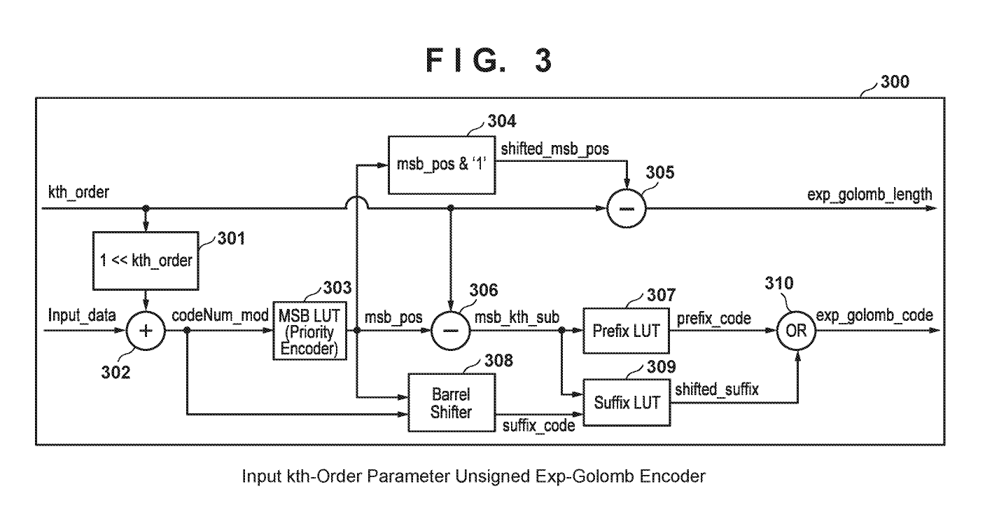

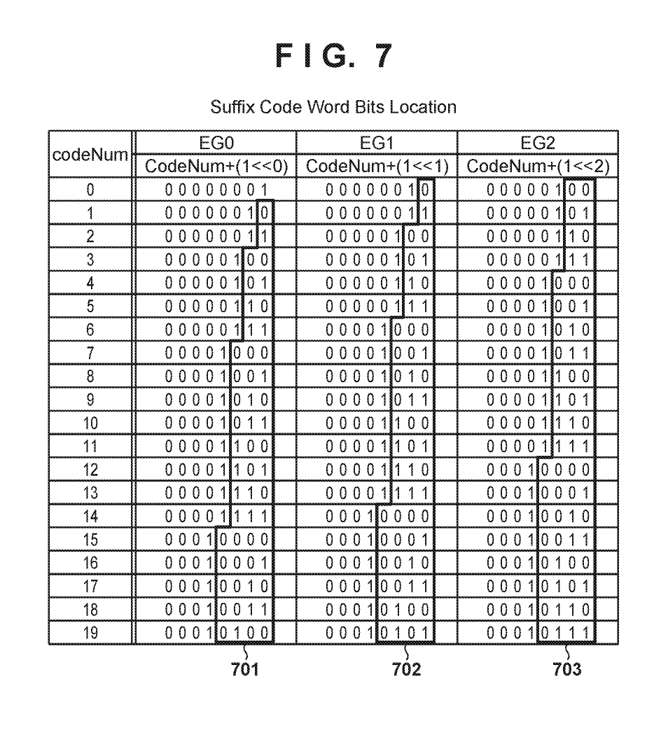

In reference with FIG. 3, units 301, 302, and 303 corresponds to 101, 102, and 103 respectively. In unit 300, kth-order parameter corresponds to an input signal named as kth_order (801 and 901), and the input integer data corresponds to input_data signal (802 and 902). In this configuration, the codeNum is equal to input_data signal. Unit 303 outputs the msb_pos (807 and 907), which specifies the MSB location of codeNum_mod. Unit 304 concatenates a ‘1’ bit at the LSB side of msb pos to generate shifted_msb_pos (808 and 908) then unit 305 subtracts the k-th order value parameter from shifted_msb_pos to generate Exp-Golomb code length (809 and 909) information. Unit 306 generates the msb_kth_sub (810 and 910) by subtracting the k-th order parameter value from msb_pos. Unit 307 outputs (811 and 911) the Exp-Golomb prefix code word (812 and 912) for the corresponding msb_kth_sub. In parallel with Exp-Golomb prefix code generation, the Exp-Golomb suffix code word bits were extracted from codeNum_mod by unit 308 and 309. In reference with FIG. 7, bits in 701, 702, and 703 are the bits extracted by 301 and 302 for EG0, EG1, and EG2 respectively. Unit 308, a barrel shifter that rotates bits from LSB side to the MSB side, formats the Exp-Golomb suffix code word bits at MSB side of suffix_code signal (806 was moved to 814; 906 was moved to 914) by shifting the MSB of shifted_msb_pos to LSB position of suffix_code (805 was moved to 815; 905 was moved to 915). Afterwards, unit 309 reformats the Exp-Golomb suffix code bits (814 was moved to 817; 914 was moved to 917) in position that corresponds to msb_kth_sub then dropping the bits at LSB side (815 and 915). The final Exp-Golomb code word (818 and 918) was generated by unit 310 by combining the Exp-Golomb prefix code word (819 is equivalent to 812; 919 is equivalent to 912) and Exp-Golomb suffix code word (820 is equivalent to 817; 920 is equivalent to 917) through bitwise-OR operation.

As described above, according to this embodiment, multiple k-th order values were supported without instantiating additional resources and components. Also, generation of suffix code word was performed in parallel with the prefix code word that reduced the critical path, the number of sequential stages required to complete the operation, from the input data to Exp-Golomb code word. Furthermore, in case of a 16-bit input, each of the LUTs in present invention, units 303, 307, and 309, will only have a size equal to 17.

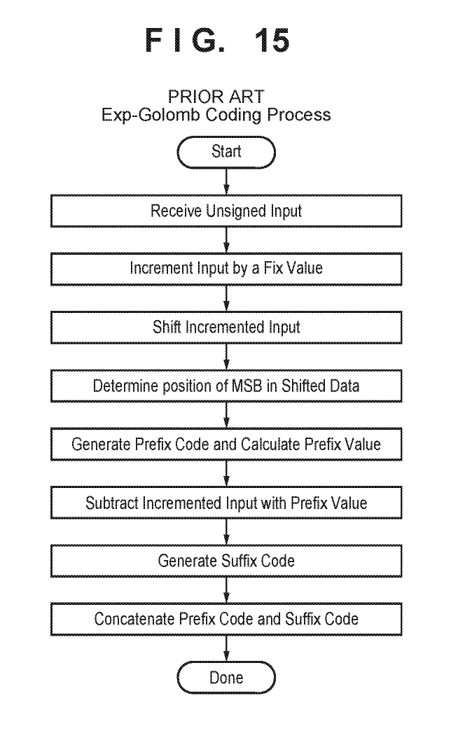

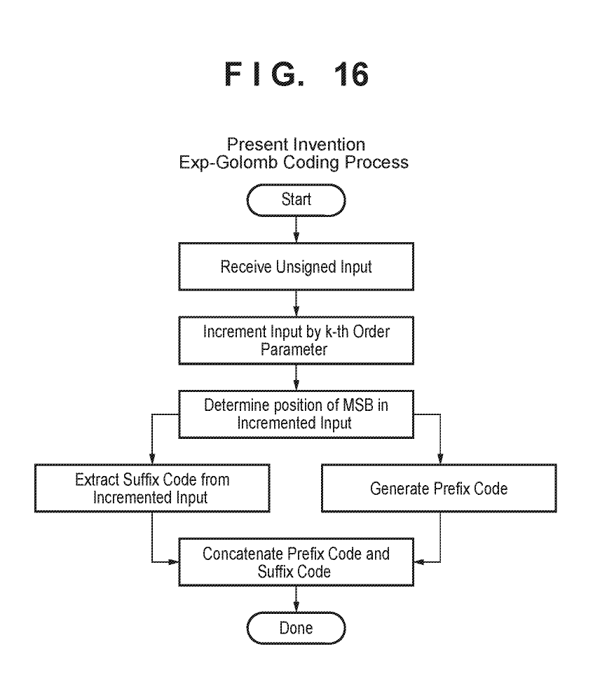

Conventionally, different large LUT are instantiated to support different k-th order parameter values. Also, in reference with FIG. 15, suffix code generation was done after prefix code and value were derived. On the other hand, in this embodiment and in reference with FIG. 16, the critical path was shortened because the Exp-Golomb prefix code word and suffix code words were generated in parallel, thus reducing the circuit size and improving synthesizability with high clock frequencies.

### Second Embodiment

Only the difference between this embodiment and the first embodiment will be described below. This embodiment is different from the first embodiment where the k-th order parameter value is set as a configurable parameter, or generic parameter, instead of an input signal. In this embodiment, only one k-th order value is supported per instance. Prior to fabrication of the circuit, the generic parameter is set to a specific value, where the effects of the k-th order parameter value are hardwired into the LUTs, thus reducing the circuit components used to derive Exp-Golomb code word.

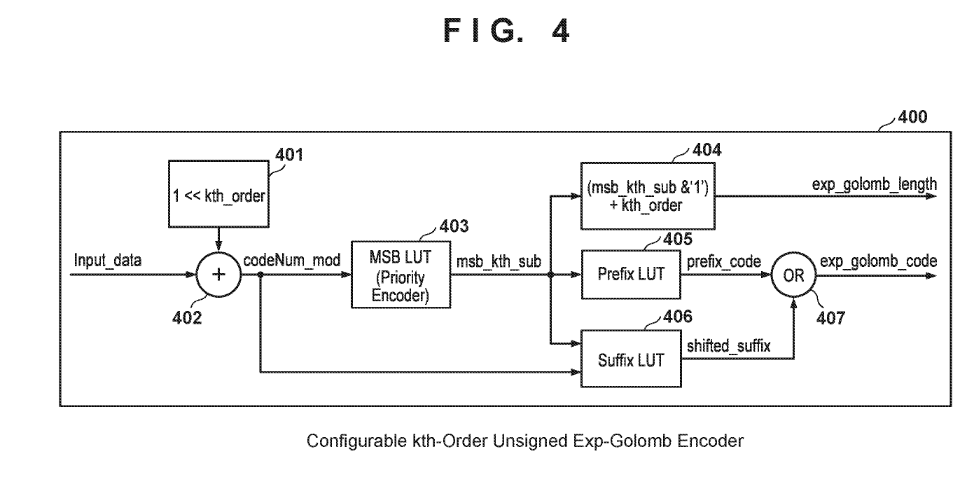

In reference with unit 400 in FIG. 4, units 402, 405, and 407 implementation are exactly the same with 302, 307, and 310 respectively. In this case, since k-th order value is fixed per instance, some components in unit 300 were removed or merged together, which further reduce the circuit size and shorten the critical path. The logic for deriving the offset value does not consume any resource since unit 401 outputs a constant value. For Exp-Golomb code generation, units 303 and 306 are merged as unit 403, and then units 308 and 309 are merged as unit 406. For Exp-Golomb code length generation, units 304 and 305 are merged as unit 404. Unit 404 concatenates a ‘1’ bit at the LSB side of msb_kth_sub then adds the kth-order parameter value, which is performed in one operation step.

As described above, according to this embodiment, the number of components was reduced compared with the first embodiment and conventional apparatus. Thus, this embodiment generates the smallest circuit with shortest critical path. Advantages of this embodiment will become apparent from the descriptions of the third and fourth embodiments.

### Third Embodiment

Since the second embodiment generates very small circuit size, supporting additional features can be realized by adding components but still maintaining the synthesizability and performance of the encoder. In this case, logic is added to select the input type as signed input or unsigned input then convert the input to codeNum as described in ITU-T Rec. H.264 or ITU-T Rec. H.265.

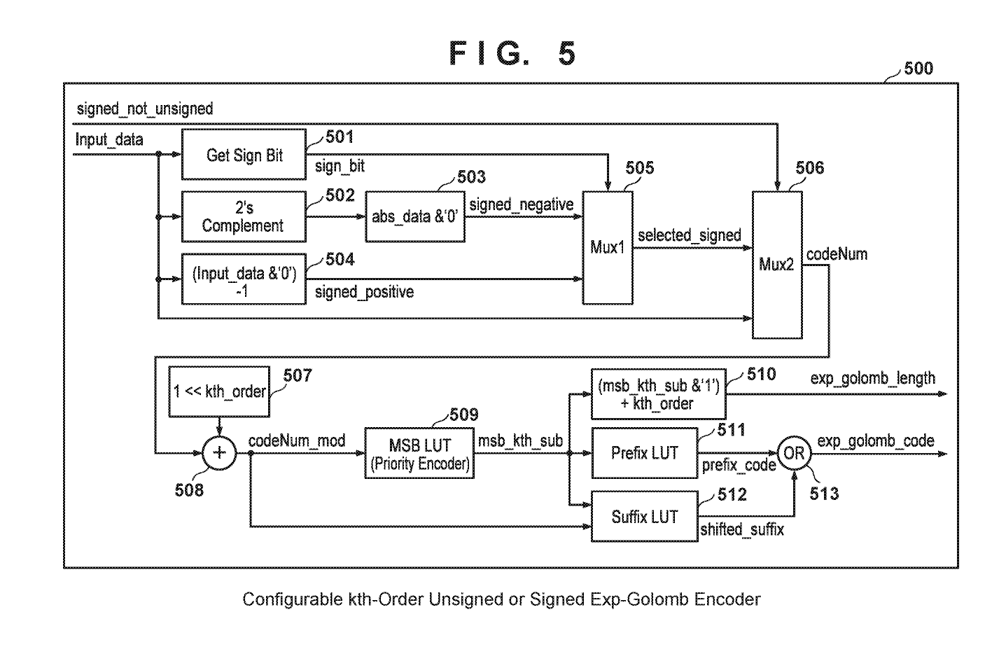

In reference with FIG. 5, units 501, 502, 503, 504, 505, and 506 were the added components to select and convert unsigned or signed input data to codeNum. Then units 507, 508, 509, 510, 511, 512, and 513 were implemented exactly the same as units 401, 402, 403, 404, 405, 406, and 407 respectively.

For the codeNum conversion logic, units 501 and 503 do not consume any resource since signal sampling and splicing were performed by respective units. For signed input operation, unit 501 samples the left most bit of the input data to determine if current value is positive or negative. Units 502 and 503 pre-generate the codeNum value for a negative input by performing 2's complement then concatenating a ‘0’ bit at LSB. At the same time, unit 504 pre-generates the codeNum value for positive input by concatenating a ‘0’ bit at LSB of the input data then decrementing the concatenated value by 1. Unit 505 then selects the codeNum that corresponds to the sign bit that was sampled by unit 501. Unit 506 selects the codeNum value based from the input parameter that specifies the input type. The output of unit 506 and received by unit 508 and from hereafter, the operation is the same with unit 400.

As described above, according to this embodiment, supported both signed and unsigned input data by adding a total of two arithmetic operators, unit 502 and 504, and two multiplexers, unit 505 and 506.

### Fourth Embodiment

Since the second embodiment generates very small circuit size, supporting additional features can be realized by adding components but still maintaining the synthesizability and performance of the encoder. During synthesis, a working circuit can only be generated within limited length of critical path. When the length of the critical path exceeds the limit, circuit fabrication will be impossible.

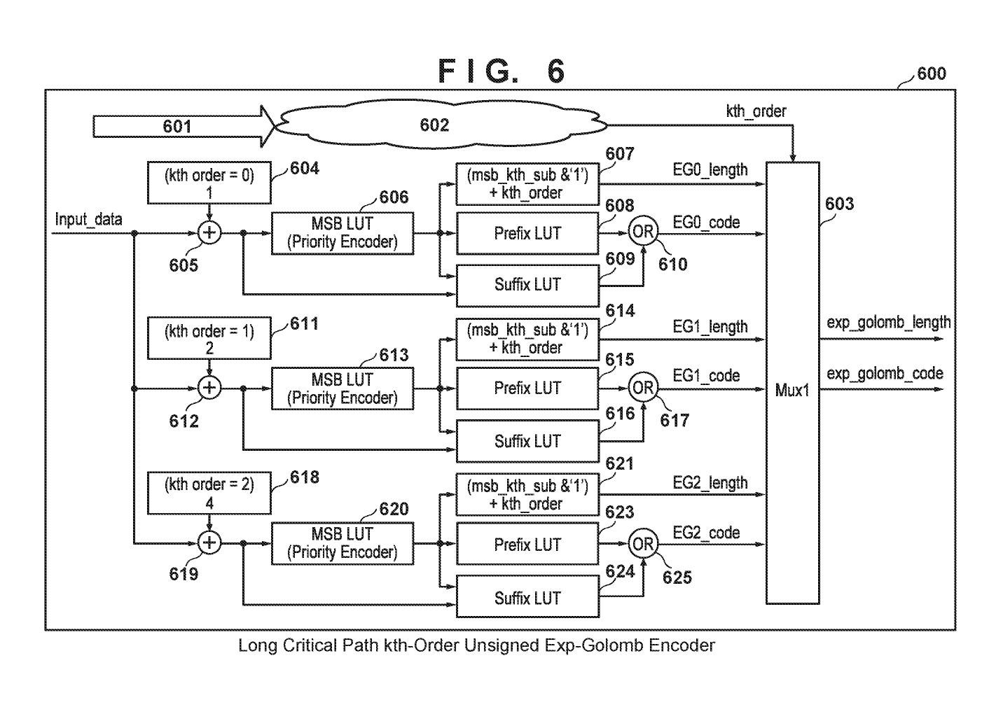

This embodiment discloses a solution in case that the derivation of k-th order parameter took a long critical path. In reference with FIG. 6, the kth-order parameter has a long critical path because the value was derived from multiple input signals, 601, and large combinational process, 602. In this configuration, the generation of Exp-Golomb code word does not prolong the critical path for kth-order parameter because the Exp-Golomb code word and length had already been generated. As an example, unit 600 supported EG0, EG1, and EG2. Unit 603 selects among pre-generated EG0, EG1, and EG2 then outputs the Exp-Golomb code word and length that corresponds to the derived kth-order parameter value.

EG0 code word and length have been pre-generated by an instance of unit 400 with k-th order parameter set to 0. Instantiated components of unit 400 for EG0 corresponds to units 604, 605, 606, 607, 608, 609, and 610. Unit 604 output a constant value of 1.

EG1 code word and length have been pre-generated by an instance of unit 400 with k-th order parameter set to 1. Instantiated components of unit 400 for EG1 corresponds to units 611, 612, 613, 614, 615, 616, and 617. Unit 611 output a constant value of 2.

EG2 code word and length have been pre-generated by an instance of unit 400 with k-th order parameter set to 2. Instantiated components of unit 400 for EG2 corresponds to units 618, 619, 620, 621, 623, 624, and 625. Unit 618 output a constant value of 4.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

As described above, according to this embodiment, multiple k-th order values were supported without prolonging the critical path for kth-order parameter value derivation. Instantiating unit 400 multiple times has increased the total size but the amount was tolerable due to the small circuit size per instance.

What is claimed is:

1. A method for compressing unsigned input of data as Exp-Golomb Code, the method comprising:
a. Deriving an offset value corresponding to kth-order parameter
b. Receiving an unsigned input data
c. Incrementing the input data by the offset value
d. Determining the most significant bit (MSB) location for the incremented value
e. Generating the suffix code word bits by extracting a plurality number of bits at left significant bit (LSB) side, that corresponds to the MSB location, from the incremented value
f. Generating the prefix code word bits code length that corresponds to the MSB location and kth-order parameter
g. Generating the output Exp-Golomb code word by combining the prefix code word and suffix code word
